(19) United States
(12) Patent Application Publication
(10) Pub. No.: US 2024/0233412 A9
(43) Pub. Date: Jul. 11, 2024

(54) MULTISPECTRAL IMAGING DEVICE, SYSTEM, AND METHOD

(71) Applicant: Synthetik Applied Technologies, LLC, Austin, TX (US)

(72) Inventors: Hayden Russell SATHER, Kington, WA (US); William Michael ROSS, Newcastle, WA (US); Eric Jordan SINGER, New Orleans, LA (US); David Kenneth MEMKE, Bainbridge Island, WA (US); David Wesley WELCH, Brandon, MS (US)

(73) Assignee: Synthetik Applied Technologies, LLC, Pierre, SD (US)

(21) Appl. No.: 18/383,837

(22) Filed: Oct. 25, 2023

Related U.S. Application Data
(60) Provisional application No. 63/419,146, filed on Oct. 25, 2022.

(51) Int. Cl. G06V 20/68; G06V 10/141; G06V 10/60; G06V 10/77; G06V 10/94; H04N 23/12

(52) U.S. Cl. CPC G06V 20/68; G06V 10/141; G06V 10/60; G06V 10/7715; G06V 10/95; H04N 23/12

(57) ABSTRACT

A multispectral imaging device and system is provided. The multispectral imaging device includes a light emitting diode (LED) array including a plurality of LEDs configured to sequentially emit light towards a target object to be scanned, each of the LEDs being configured to emit a differing wavelength from one another; a scanning hood configured to house the LED array; a luminosity sensor configured to capture luminosity data of each light emitted by the plurality of LEDs and reflected from the target object; a printed circuit board (PCB) configured to provide electronic connections and mounting surfaces for the LED array and the luminosity sensor; a housing configured encase the PCB; and a trigger configured to initiate operation of the LED array. The multispectral imaging system further includes a computer configured to apply one or more artificial intelligence (AI) or machine learning (ML) algorithms to the luminosity data of the target object for determining an identity and/or origin of the target object.

### REFERENCE TO RELATED APPLICATION

The present application claims priority to U.S. Provisional Patent Application No. 63/419,146 to Sather et al., entitled “Multispectral Imaging Device and System,” filed on Oct. 25, 2022, the entirety of which is fully incorporated by reference herein.

### BACKGROUND OF THE DISCLOSURE

### Field of the Disclosure

This disclosure generally relates to multispectral imaging devices, systems, and methods for capturing luminosity data for a target area of an object to be identified and for identifying an object using the captured luminosity data of the object.

### Description of the Related Art

Recently, there has been a large amount of seafood that is mislabeled and sold as a different species (e.g., common sole vs. pangasius) or origin (e.g., wild vs. farm-raised, East Coast vs. West Coast, or the like) of seafood, as well as seafood sold with adulterants present. However, based on similarity in appearances, it is often difficult to verify the correct identity of the seafood without special equipment that may easily and quickly identify a large volume of seafood that may be present in a supply chain.

### SUMMARY OF THE DISCLOSURE

According to an aspect of the present disclosure, a multispectral imaging device is provided. The multispectral imaging device includes a light emitting diode (LED) array comprising a plurality of LEDs configured to sequentially emit light towards a target object to be scanned, each of the LEDs being configured to emit a differing wavelength from one another; a scanning hood configured to house the LED array; a luminosity sensor configured to capture luminosity data of each light emitted by the plurality of LEDs and reflected from the target object; a printed circuit board (PCB) configured to provide electronic connections for the LED array and the luminosity sensor; an onboard processor configured to control activation sequence of the LED array and the luminosity sensor; a housing configured to encase the PCB and onboard processor; and a trigger configured to initiate operation of the device and connected to said housing.

According to another aspect of the present disclosure, the plurality of LEDs includes six LEDs.

According to another aspect of the present disclosure, the plurality of LEDs includes seven LEDs.

According to yet another aspect of the present disclosure, the plurality of LEDs includes eight LEDs.

According to another aspect of the present disclosure, the plurality of LEDs is activated to emit light when the scanning hood contacts the target object.

According to a further aspect of the present disclosure, a communication circuit configured to perform a short-range communication with a client device.

According to yet another aspect of the present disclosure, the short-range communication is wireless communication, such as Bluetooth communication.

According to a further aspect of the present disclosure, each of the plurality of the LEDs emits light within a 20 nm to 50 nm band around a specified target value.

According to another aspect of the present disclosure, one or more artificial intelligence or machine learning algorithms are applied to the luminosity data to determine an origin of the target object.

According to a further aspect of the present disclosure, one or more artificial intelligence or machine learning algorithms are applied to the luminosity data to determine an identification of the target object.

According to an aspect of the present disclosure, a multispectral imaging system is provided. The multispectral imaging system includes a multispectral imaging device and a computer. The multispectral imaging device includes a light emitting diode (LED) array including a plurality of LEDs configured to sequentially emit light towards a target object to be scanned, each of the LEDs being configured to emit a differing wavelength from one another; a scanning hood configured to house the LED array and isolate the scanned material; a luminosity sensor configured to capture luminosity data of each light emitted by the plurality of LEDs and reflected from the target object; a printed circuit board (PCB) configured to provide electronic connections for the LED array and the luminosity sensor; a housing configured encase the PCB and onboard processor; and a trigger configured to initiate operation of the device. The computer is configured to apply one or more artificial intelligence (AI) or machine learning (ML) algorithms to the luminosity data of the target object for determining an identity and/or origin of the target object.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system in accordance with an exemplary embodiment of the present disclosure;

FIG. 2 illustrates a multispectral imaging system in accordance with an exemplary embodiment of the present disclosure;

FIG. 3A illustrates an exploded view of a handheld multispectral imaging device in accordance with an exemplary embodiment of the present disclosure;

FIGS. 3B-3E illustrate various views of the handheld multispectral imaging device according to the embodiment shown in FIG. 3A;

FIG. 4 illustrates intensity spectra of an individual light emitting diode (LED) included in an LED array in accordance with an exemplary embodiment of the present disclosure;

FIG. 5A illustrates a user interface for performing artificial intelligence (AI) or machine learning (ML) analysis in accordance with an exemplary embodiment of the present disclosure;

FIG. 5B illustrates a user interface for capturing luminosity data using an onboard camera on a mobile communication device in accordance with an exemplary embodiment of the present disclosure; and

FIG. 6 illustrates a method for capturing luminosity data of an object and determining an identity of the object based on the luminosity data in accordance with an exemplary embodiment of the present disclosure.

### DETAILED DESCRIPTION OF THE DISCLOSURE

In the following detailed description, numerous specific details are set forth in order to provide a more thorough understanding of embodiments incorporating features of the present disclosure. However, it will be apparent to one skilled in the art that devices, methods, and systems according to the present disclosure can be practiced without necessarily being limited to these specifically recited details. Through one or more of its various aspects, embodiments and/or specific features or sub-components of the present disclosure, are intended to bring out one or more of the advantages as specifically described above and noted below.

The examples provided herein may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Throughout this disclosure, the embodiments illustrated should be considered as exemplars, rather than as limitations on the present disclosure. As used herein, the term “composition,” “device,” “structure,” “method,” “system,” “disclosure,” “present composition,” “present device,” “present structure,” “present method,” “present system,” or “present disclosure” refers to any one of the embodiments of the disclosure described herein, and any equivalents. Furthermore, reference to various feature(s) of the “composition,” “device,” “structure,” “method,” “system,” “disclosure,” “present composition,” “present device,” “present structure,” “present method,” “present system,” “present apparatus,” or “present disclosure” throughout this document does not mean that all claimed embodiments or methods must include the reference feature(s).

Furthermore, any element in a claim that does not explicitly state “means for” performing a specified function, or “step for” performing a specific function, is not to be interpreted as a “means” or “step” clause as specified in 35 U.S.C. § 112, for example, in 35 U.S.C. § 112(f) or pre-AIA 35 U.S.C. § 112, sixth paragraph. In particular, the use of “step of” or “act of” in the claims herein is not intended to invoke the provisions of 35 U.S.C. § 112.

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Furthermore, relative terms such as “left,” “right,” “front,” “back,” “top,” “bottom′” “forward,” “reverse,” “clockwise,” “counter-clockwise,” “outer,” “inner,” “above,” “upper,” “lower,” “below,” “horizontal,” “vertical,” and similar terms, have been used for convenience purposes only and are not intended to imply any particular fixed direction. Instead, they are used to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although ordinal terms, e.g., first, second, third, etc., may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

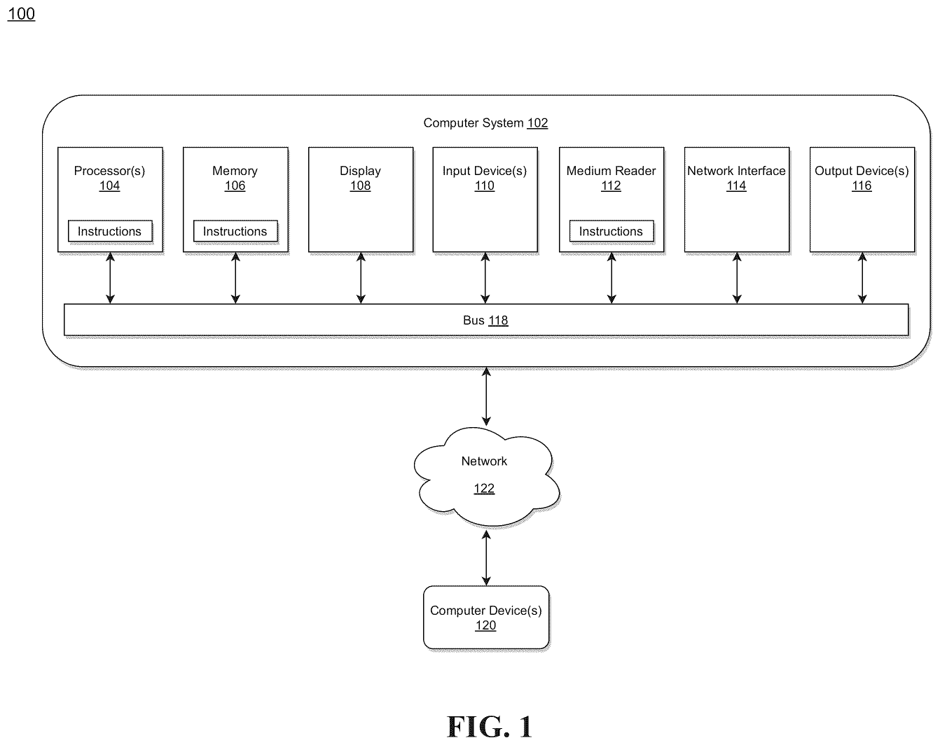

FIG. 1 illustrates a computer system for implementing a multispectral imaging system (MIS) in accordance with an exemplary embodiment according to the present disclosure.

The system 100 is generally shown and may comprise a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environments. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104 (referred to herein in the singular for simplicity). The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include at least one computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display, or combination of displays.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or other input devices known in the art, or any combination of the foregoing. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112, which is configured to read any one or more sets of instructions, e.g., software, from any of the memories 106 described herein. The instructions, when executed by the processor 104, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof, which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the computer device 120 may be any additional device or apparatus commonly known and understood in the art without departing from the scope of the present application. For example, the computer device 120 may be the same or similar to the computer system 102.

Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

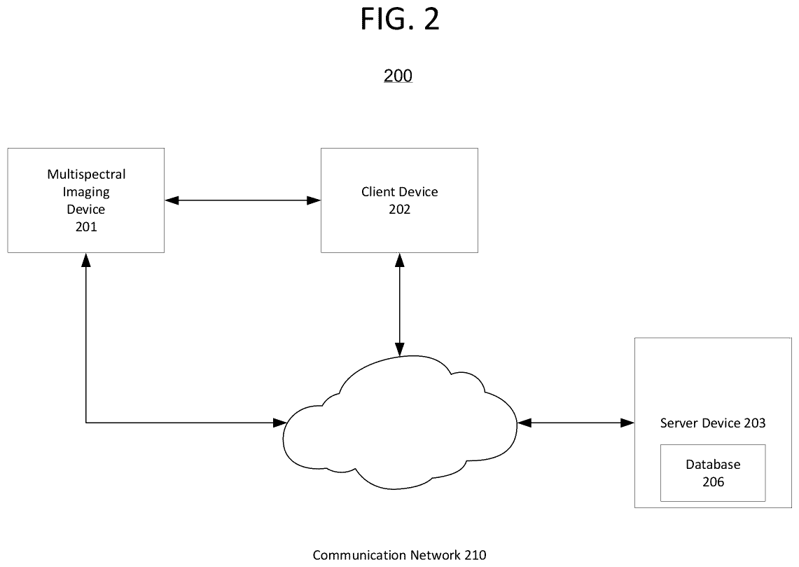

FIG. 2 illustrates a multispectral imaging system 200 in accordance with an exemplary embodiment.

The multispectral imaging system 200 of FIG. 2 includes a multispectral imaging device 201, a client device 202, and a server device 203. The multispectral imaging device 201, the client device 202, and/or the server device 203 may communicate with one another via a communication network 210.

According to exemplary aspects, the multispectral imaging device 201 may be a low-cost, handheld multispectral imaging tool designed for material differentiation of a relatively homogenous object. In an example, the multispectral imaging device 201 may be configured with multiple LEDs that sequentially emit lights of differing wavelengths and a luminosity sensor that captures reflectance data as the light reflects from a surface of a seafood sample. According to exemplary aspects, the multispectral imaging device 201 may capture luminosity data and not two-dimensional or RGB data for more efficient data capture and quicker processing by a computing device. However, aspects of the present disclosure are not limited thereto, such that two-dimensional or RGB data may be captured in combination with or alternative to the luminosity data.

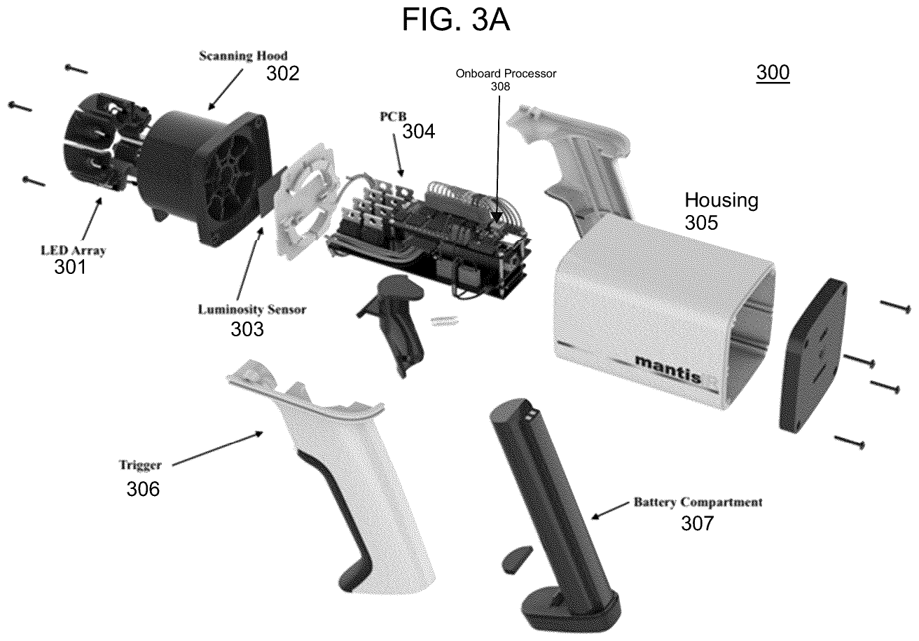

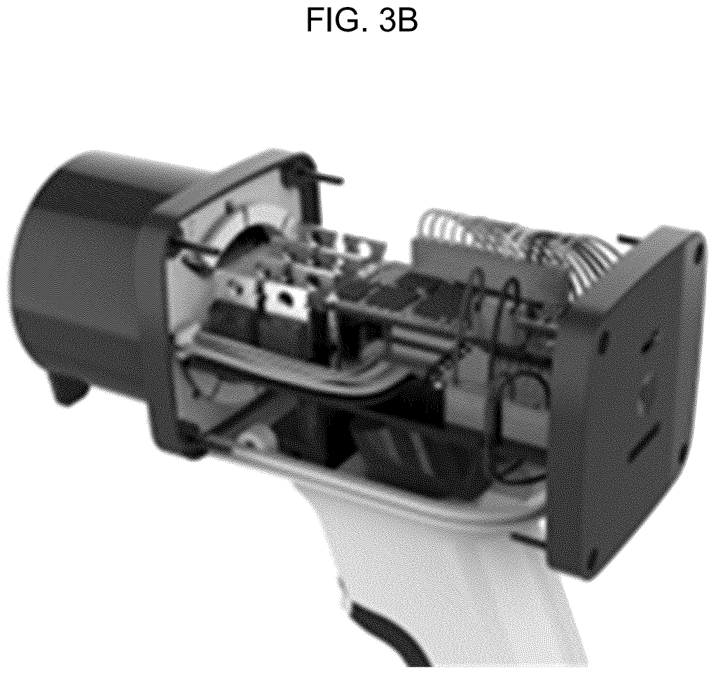

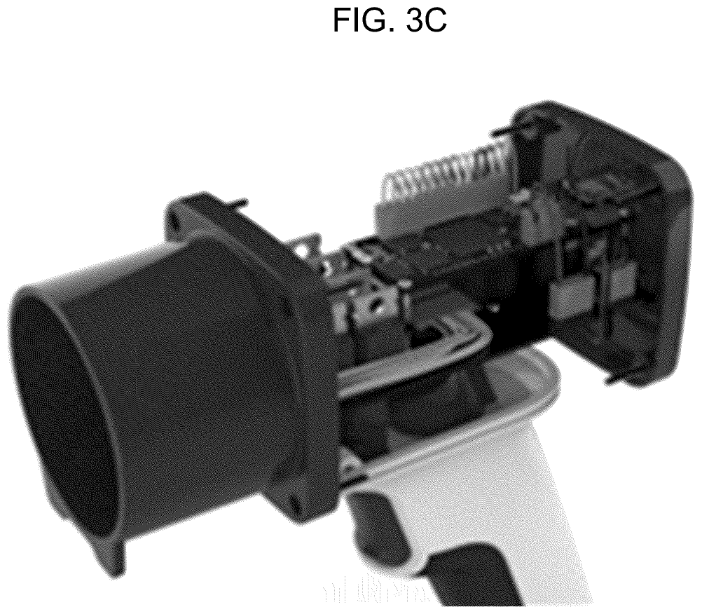

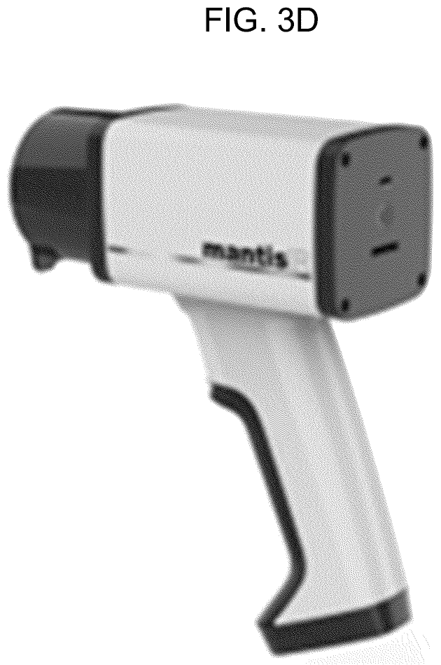

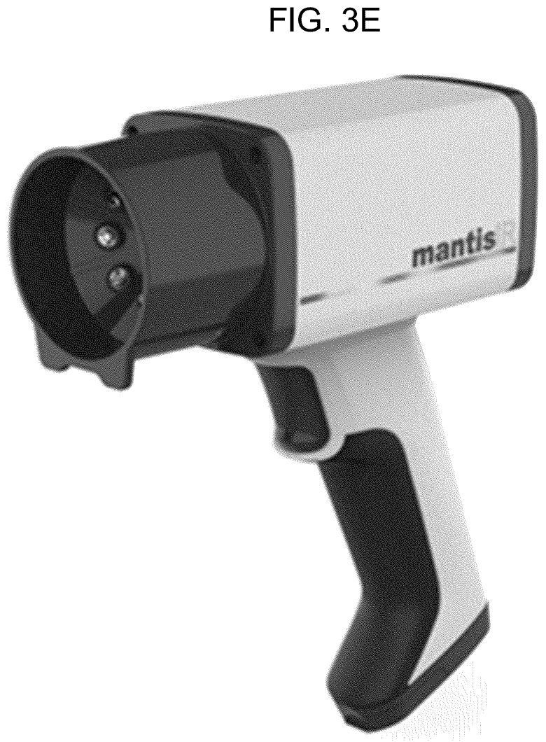

Further, the multispectral imaging device 201 may communicate directly with the client device 202 via a short-range communication (e.g., Bluetooth, NFC, RFID or the like) or via a wired communication. Detailed configuration of the multispectral imaging device 201 may be described in more detail with respect to FIGS. 3A-3E provided below.

Although the multispectral imaging device 201 is described as being utilized for characterization of seafood samples, aspects of the present disclosure are not limited thereto, such that the multispectral imaging device 201 may be applied to a wide range of differentiation tasks where reflectance differs in the visible, near-infrared, or short-wave infrared spectra. According to exemplary aspects, an underlying design principle may rely on the assumption that spatial or two-dimensional (2D) characteristics are not necessary for classification, and that an area-based average of reflectance values at various wavelengths is sufficient for the differentiation task at hand. This assumption is supported by previous analysis of captured 2D hyperspectral imagery of whitefish species, where it was observed that classification of species could be achieved by averaging spectral values over a small region of the fish, as well as a limited subset of spectral values.

The client device 202 may be implemented with one or more computer systems similar to the computer system 102 as described with respect to FIG. 1.

The client device 202 may store one or more applications that can include executable instructions that, when executed by the client device 202, cause the client device 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the client device 202 itself, may be located in virtual server(s) running in a cloud-based computing environment rather than being tied to one or more specific physical network computing devices. Also, the application(s) may be running in one or more virtual machines (VMs) executing on the client device 202. Additionally, in one or more embodiments of this technology, virtual machine(s) running on the client device 202 may be managed or supervised by a hypervisor.

In the multispectral imaging system 200 of FIG. 2, the client device 202 is coupled to a server device 203 that hosts a database 206. According to exemplary aspects, database 206 may be configured to store data that relates to luminosity data associated with seafood. However, aspects of the present disclosure are not limited thereto, such that the database 206 may store luminosity data associated with other objects or goods. A communication interface of the client device 202, such as the network interface 114 of the computer system 102 of FIG. 1, operatively couples and communicates between the client device 202 and the server device 203, which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the client device 202, the server device 203, and/or the multispectral imaging device 201 may be coupled together via other topologies. Additionally, the multispectral imaging system 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The client device 202 may be a standalone device or integrated with one or more other devices or apparatuses, such as one or more of the server device 203, for example. In one particular example, the client device 202 may be hosted by the server device 203, and other arrangements are also possible. Moreover, one or more of the devices of the client device 202 may be in the same or a different communication network including one or more public, private, or cloud networks, for example.

The server device 203 may be the same or similar to the computer system 102 or the computer device 120 as described with respect to FIG. 1, including any features or combination of features described with respect thereto. For example, the server device 203 may include, among other features, one or more processors, a memory, and a communication interface, which are coupled together by a bus or other communication link, although other numbers and/or types of network devices may be used. The server device 203 in this example may process requests received from the client device 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server device 203 may be hardware or software or may represent a system with multiple servers in a pool, which may include internal or external networks. The server device 203 hosts the database 206 that is configured to store metadata sets, data quality rules, and newly generated data.

Although the server device 203 is illustrated as a single device, one or more actions of the server device 203 may be distributed across one or more distinct network computing devices that together comprise the server device 203. Moreover, the server device 203 is not limited to a particular configuration. Thus, the server device 203 may contain a plurality of network computing devices that operate using a primary/secondary approach, whereby one of the network computing devices of the server device 203 operates to manage and/or otherwise coordinate operations of the other network computing devices.

The server device 203 may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

Although the exemplary multispectral imaging system 200 with the client device 202, the server device 203, the multispectral imaging device 201, and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the multispectral imaging system 200, such as the client device 202, or the server device 203, for example, may be configured to operate as virtual instances on the same physical machine. For example, one or more of the client device 202 and the server device 203 may operate on the same physical device rather than as separate devices communicating through communication network(s) 210. Additionally, there may be more of client device 202 and server device 203 than illustrated in FIG. 2. According to exemplary embodiments, the client device 202 may be configured to send code at run-time to remote server device 203, but the disclosure is not limited thereto. In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

According to exemplary aspects, the multispectral imaging device 201 may capture luminosity data when scanning a target object (e.g., seafood sample), and transmit the captured luminosity data to the client device 202 via a short-range communication, other wireless communication, or a wired communication. The client device 202 in response may process the luminosity data locally for identification of the target object, and/or transmit the acquired luminosity data to the server device 203 for identification of the target object. According to exemplary aspects, the client device 202 and/or the server device 203 may perform identification of the target object based on the luminosity data acquired by the multispectral imaging device 201 using one or more artificial intelligence (AI) or machine learning (ML) algorithms.

Generally, AI or ML algorithms may be executed to perform data pattern detection, and to provide an output or render a decision based on the data pattern detection. More specifically, an output may be provided based on a historical pattern of data, such that with more data or more recent data, more accurate outputs and/or decisions may be provided or rendered. Accordingly, the ML or AI models may be constantly updated after a predetermined number of runs or iterations. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, artificial neural network analysis, k-medoids analysis, regression analysis, decision tree analysis, random forest analysis, k-nearest neighbors analysis, logistic regression analysis, k-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

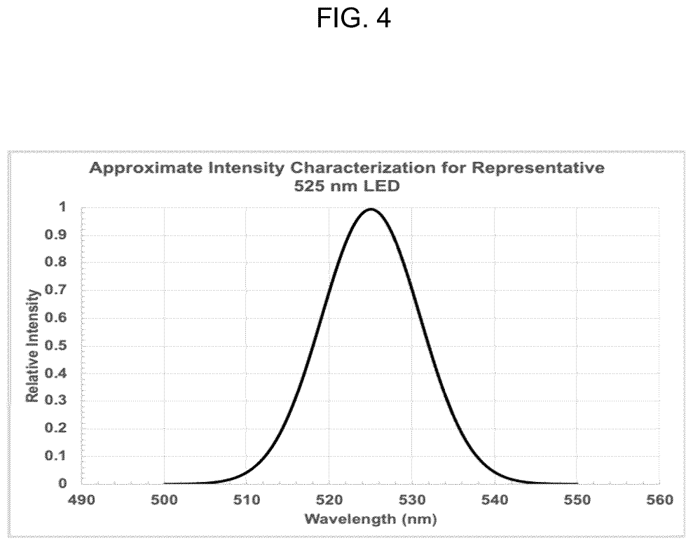

FIGS. 3A-3E illustrate various views of a handheld multispectral imaging device in accordance with an exemplary embodiment. FIG. 4 illustrates intensity spectra of an individual light emitting diode (LED) included in an LED array in accordance with an exemplary embodiment.

As illustrated in FIG. 3A, a handheld multispectral imaging device 300 includes a light emitting diode (LED) array 301, a scanning hood 302, a luminosity sensor 303, a printed circuit board (PCB) 304, a main housing 305, a trigger 306, a battery compartment 307, and an onboard processor 308. Although not illustrated, the handheld multispectral imaging device may be equipped with a network card for performing wireless communication with a network. Further, the handheld multispectral imaging device 300 may be equipped with a short-range communication component for performing short distance communication (e.g., Bluetooth, nearfield communication, RFID and the like) with a mobile terminal. In addition to the above, the handheld multispectral imaging device may also be equipped with one or more ports, such as a USB port, for establishing a hardware connection with a computing device.

The LED array 301 may include multiple LEDs arranged in a circular array. Although a circular arrangement is illustrated in FIG. 3A, aspects of the present disclosure are not limited thereto, such that the array of LEDs may be configured in a different arrangement or shape. The LED array 301 may include six to eight LEDs in the exemplary embodiment illustrated in FIG. 3A. However, based on the device's purpose and the required accuracy of data, the number of LEDs may be modified to differing numbers, with a minimum of at least two LEDs. Although an array of LEDs are disclosed herein, aspects of the present disclosure are not limited thereto, such that an array of different sensors or combination of sensors may be utilized.

According to exemplary aspects each of the LEDs included in the LED array 301 may be fired or turned-on consecutively in a predetermined sequence to emit specific wavelengths of light towards a surface of an object being imaged or scanned, which will in turn be reflected for measurement by the luminosity sensor 303. However, aspects of the present disclosure are not limited thereto, such that the LEDs may be contemporaneously turned on. Further, the LEDs included in the LED array 301 may be selectively turned on if not all of the LEDs are necessary for its imaging purpose, or when a lower level of accuracy is acceptable or smaller data size is desirable.

According to exemplary aspects, the LED array 301 may be configured to be modular. Further, the array of LEDs may be tuned or configured to relatively narrow bands of illumination within the visible and near-infrared spectrum. LEDs may be used with majority of intensities occurring within a 20 nm to 50 nm band around a specified target value. Further, individual LEDs may be selected by wavelength to optimize for a particular classification task. In an example, baseline configuration for a six-unit LED array may include the following wavelength values:
LED unit 1: 405 nm
LED unit 2: 450 nm
LED unit 3: 525 nm
LED unit 4: 570 nm
LED unit 5: 610 nm
LED unit 6: 890 nm

FIG. 4 exemplarily illustrates intensity spectra for the LED unit 3 525 nm noted above. As illustrated in FIG. 4, the normalized intensities may range from approximately 505 nm to 545 nm, while peaking at 525 nm.

The scanning hood 302 may be configured to house the LED array 301. As illustrated in FIG. 3E, the array of LEDs may be disposed on internal wall structure of the scanning hood 302. Further, edges of the scanning hood 302 may extend beyond the LEDs. The LEDs may be circular in shape, however, aspects of the present disclosure are not limited thereto, such that LEDs may be in configured in a different shape. According to exemplary aspects, the scanning hood 302 may be configured with overhang to block influence of external lighting when imaging or scanning an object with the handheld multispectral imaging device. In an example, the scanning hood 302 may be flexible to adapt to a shape of a surface when the scanning hood 302 comes into contact with the surface of an object being imaged. However, aspects of the present disclosure are not limited thereto, such that the scanning hood 302 may be rigid, or may be configured to have rigid portions and flexible portions.

The luminosity sensor 303 may be centrally positioned at an opposite end of the LED array 301. According to exemplary aspects, the luminosity sensor 303 may capture luminosity data that is reflected from a surface of an object each time light is emitted from an LED of the LED array 301 towards the object to be imaged or scanned. The reflectance may be measured by a high-range luminosity sensor, such as the luminosity sensor 303, as each LED of the LED array 301 is illuminated. The resulting series of measures may provide a multi-spectral fingerprint of the aggregate material contained within or positioned in front of the sensor hood 302. In an example, the series of reflectance measurements may provide a basis for downstream machine learning-based inferencing.

In an example, luminosity data is captured by the luminosity sensor 303, as a result of light reflected from a small area of a particular fish filet. Based on the luminosity data captured from an imaged surface area, a particular species of the imaged or scanned fish may be identified. The image surface area may be a surface area of the object (e.g., fish) corresponding to a size of the scanning hood 302 or smaller. In an example, a single image or scan may be sufficient to indicate a species of a scanned fish. According to exemplary aspects, imaging or scanning of a limited surface area may be sufficient to identify a particular species of the scanned or imaged fish.

More specifically, when the LED array 301 emits light towards a surface of an object being scanned, at least a portion of the emitted light from each of the LEDS included in the LED array 301 is reflected and measured by the luminosity sensor 303. The measured luminosity data is then transmitted to a computing device over a network for performing AI or ML analysis to predict classes related to object (e.g., seafood) identification.

The LED array 301 and the luminosity sensor 303 may be connected to and/or mounted to the PCB 304. The PCB 304 may facilitate processing, receiving, transmitting and/or storing of the captured luminosity data. Further, the PCB 304 may be configured to interface with the onboard processor 308 (e.g., Arduino Portenta) and/or other software/hardware to facilitate onboard processing, short-range (Bluetooth) connectivity, data storage, and ports for wired connection. For example, rechargeable batteries may be stored in the battery compartment 307 of the multispectral imaging device and may be rechargeable through the onboard USB ports.

According to exemplary aspects, the onboard processor 308 may be configured with code that dictates illumination of the LEDs included in the LED array 301, and coordinates with the luminosity sensor 303 to capture luminosity data for respective LEDs as they are individually illuminated in a specific sequence. Moreover, the onboard processor 308 may additionally be configured with code that dictates operation of the Bluetooth receiver, USB ports and the like.

The housing 305 may be configured to safely house the PCB 304 and encased with the scanning hood 302 on one end and a face plate on the other end. Both FIG. 3B and FIG. 3C illustrate the PCB 304 disposed between the scanning hood 302 and the face plate. The housing 305 may also connect with one or more of the trigger 306 and the battery compartment 307. FIG. 3D and FIG. 3E illustrate an assembled multispectral device, in which the PCB 304 is encased in the housing 305.

The trigger 306 may be operated to perform an imaging or scanning operation. In an example, once a user operates the trigger 306, LEDs in the LED array may be illuminated in a sequential order for sequentially emitting lights of specific wavelengths, which will then be reflected and measured by the luminosity sensor 303.

The battery compartment 307 may store one or more batteries for powering the multispectral imaging device. According to exemplary aspects, the one or more batteries may include high-capacity rechargeable batteries or disposable batteries. However, aspects of the present disclosure is not limited thereto, such that an ac adapter may be used in lieu of batteries. It is understood that other methods of supplying power to the device are possible.

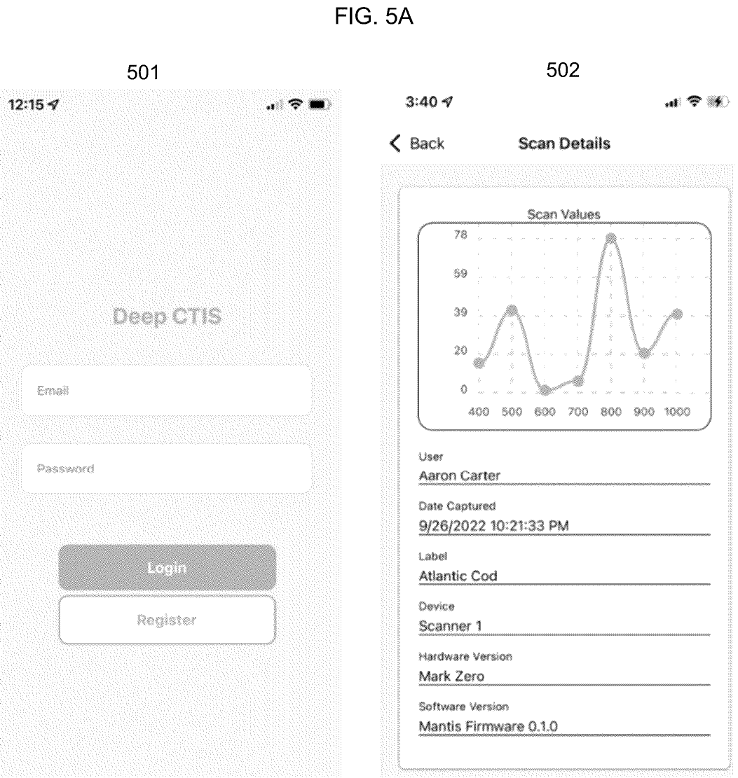

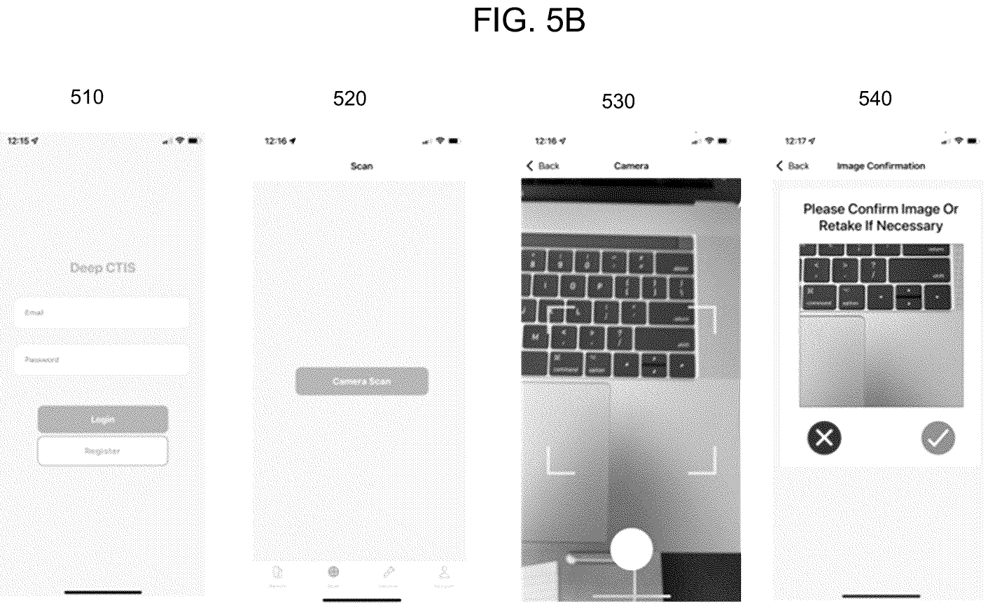

FIG. 5A illustrates a user interface for performing artificial intelligence (AI) or machine learning (ML) analysis in accordance with an exemplary embodiment.

Screen 501 illustrates an initial login screen. According to exemplary aspects, the user may be prompted to enter an email address and password for logging into the image processing application. Although email address is disclosed as being utilized, aspects of the present disclosure are not limited thereto, such that a username, phone number or other identifier may be utilized. Alternatively, user credentials may be omitted.

Upon successful login, screen 502 may be displayed providing scanned luminosity values for scans performed with a scanning device, as well as an identity of the scanned seafood specimen (e.g., Atlantic Cod) based on AI or ML analysis result based on the scanned luminosity values. In an example, AI or ML analysis may be performed locally by the device providing the user interface, such as a mobile communication device. Alternatively, AI or ML analysis may be performed on a server, which may transmit its result back to the mobile communication device for display thereof. According to exemplary aspects, a scanning device may be a multispectral imaging device of FIG. 3. Screen 502 may also provide with image capture time stamp information, as well as device identifier, hardware version information, and software version information.

FIG. 5B illustrates a user interface for capturing luminosity data using an onboard camera on a mobile communication device in accordance with an exemplary embodiment.

Although exemplary aspects of the present disclosure provide a multispectral imaging device for capturing luminosity data of seafood products, aspects of the present disclosure are not limited thereto, such that AI or ML analysis may be applied to images captured by onboard cameras provided on a personal mobile communication device, such as a smart phone. Based on an object to be imaged and/or analyzed, an ordinary mobile communication device may be leveraged for capturing of image data for AI or ML processing.

With reference to FIG. 5B, screen 510 illustrates an initial login screen, which may be the same as or similar to screen 501. According to exemplary aspects, the user may be prompted to enter an email address and password for logging into the image processing application. Although email address is disclosed as being utilized, aspects of the present disclosure are not limited thereto, such that a username, phone number or other identifier may be utilized. Alternatively, user credentials may be omitted.

Upon successful login, screen 520 may be displayed for receiving an input. The screen 520 may provide an input icon for initializing a camera scanning operation of the mobile communication device.

In screen 530, an image capturing operation may be performed with the mobile communication device. For example, upon the desired positioning of the mobile communication device, a trigger or other operating mechanism may be utilized for capturing or scanning an image of a target object.

Screen 540 may provide a preview of the image to be processed before the captured or scanned image is submitted for AI or ML processing. By providing the preview screen for receiving confirmation, unnecessary expenditure of computing resources may be avoided until the user first confirms that the captured image is of sufficient quality prior to performing AI or ML processing. If the captured image is deemed insufficient, the user may select to scrap the image taken to capture another picture for performing AI or ML processing. Once the AI or ML processing has been performed, a results screen the same as or similar to screen 502 of FIG. 5A may be provided.

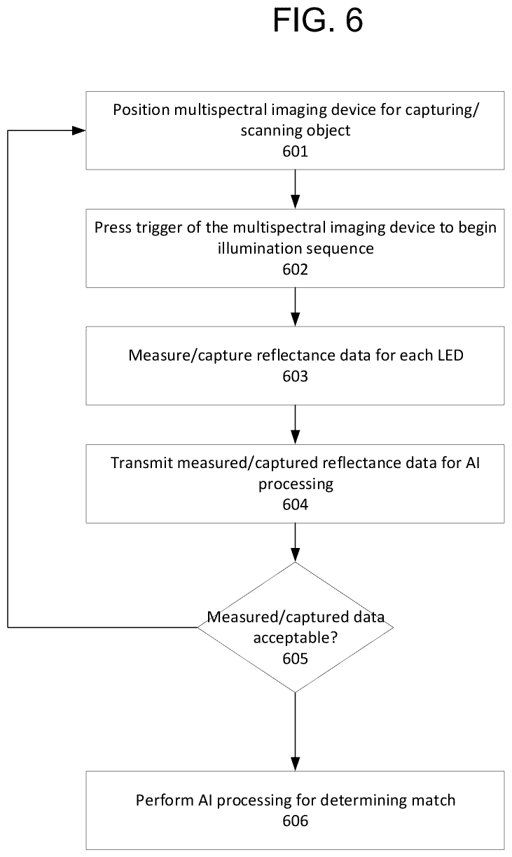

FIG. 6 illustrates a method for capturing luminosity data of an object and determining an identity of the object based on the luminosity data in accordance with an exemplary embodiment.

In operation 601, a user may position a multispectral imaging device for capturing reflectance data of a target object. According to exemplary aspects, the multispectral imaging device may be positioned to contact the target object prior to scanning or capturing of reflectance data. However, aspects of the present disclosure are not limited thereto, such that the multispectral imaging device may be positioned not to touch the target object.

In operation 602, once the multispectral imaging device is positioned for performing the scanning operation, a user may press a trigger provided on the multispectral imaging device to begin an illumination sequence. According to exemplary aspects, the multispectral imaging device may have multiple LEDs that may turn on according to a particular sequence to emit light of differing wavelengths toward the target object.

In operation 603, the emitted light is then reflected from a surface of the target object and towards a luminosity or reflectance sensor, which may capture reflectance or luminosity data of each LED.

In operation 604, the captured reflectance or luminosity data is then transmitted to a computing device for performing AI or ML analysis for determining an identity (e.g., a fish species, such as common sole vs. pangasius) and/or origin (e.g., wild vs. farm-raised, East Coast vs. West Coast, or the like) of the target object.

In operation 605, a determination of whether the reflectance or luminosity data is sufficient for performing AI or ML processing is determined. If the reflectance or luminosity data is determined to be insufficient for performing AI or ML processing, the method proceeds back to operation 601. On the other hand, if the reflectance or luminosity data is determined to be sufficient for performing AI or ML processing, the method proceeds to operation 606.

In operation 606, one or more AI or ML algorithms are applied to the reflectance or luminosity data for determining the identity and/or origin of the target object. At least since the AI or ML algorithms are applied to luminosity data of a small region of the target object, which may be smaller than conventional RGB data, quicker determination of the identity and/or origin of the target object may be rendered. Further, due to quicker processing and lighter data requirements, multispectral imaging scanning may be deployed across various supply chains for curbing counterfeit seafood goods.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A multispectral imaging device comprising:
a light emitting diode (LED) array comprising a plurality of LEDs configured to sequentially emit light towards a target object, each of said LEDs being configured to emit a differing light wavelength from one another;
a scanning hood configured to house said LED array;
a luminosity sensor configured to capture luminosity data of each light emitted by said plurality of LEDs and reflected from said target object;
a printed circuit board (PCB) configured to provide electronic connections for said LED array and the luminosity sensor;
an onboard processor configured to control activation sequence of said LED array and said luminosity sensor;
a housing configured to encase said PCB and said onboard processor and to connect to said luminosity sensor and said scanning hood; and
a trigger configured to control operation of said device and connected to said housing.

2. The multispectral imaging device according to claim 1, wherein said plurality of LEDs includes six LEDs.

3. The multispectral imaging device according to claim 1, wherein said plurality of LEDs includes seven LEDs.

4. The multispectral imaging device according to claim 1, wherein said plurality of LEDs includes eight LEDs.

5. The multispectral imaging device according to claim 1, wherein said plurality of LEDs is configured to emit light when said scanning hood contacts said target object.

6. The multispectral imaging device according to claim 1, further comprising a communication circuit configured to perform a short-range communication with a client device.

7. The multispectral imaging device according to claim 6, wherein said short-range communication is wireless communication.

8. The multispectral imaging device according to claim 6, wherein said client device is a computer.

9. The multispectral imaging device according to claim 1, wherein each of said plurality of the LEDs emits light within a 20 nm to 50 nm band around a specified target wavelength.

10. The multispectral imaging device according to claim 1, wherein one or more artificial intelligence or machine learning algorithms are applied to said luminosity data to determine an origin of said target object.

11. The multispectral imaging device according to claim 1, wherein one or more artificial intelligence or machine learning algorithms are applied to said luminosity data to determine an identification of said target object.

12. The multispectral imaging device according to claim 1 further comprising a power source.

13. A multispectral imaging system, comprising:
the multispectral imaging device of claim 1; and
a computer communicatively connected to said multispectral imaging device, wherein said computer is configured to apply one or more artificial intelligence (AI) or machine learning (ML) algorithms to the luminosity data of the target object for determining an identity and/or origin of the target object.

14. A method for identifying an unknown object using luminosity data comprising:
positioning a multispectral imaging device for capturing reflectance data of a target object;
activating said multispectral imaging device to begin an illumination sequence;
capturing said reflectance data of said target object;
transmitting said captured reflectance data to a computing device for performing artificial intelligence or machine learning processing to identify said target object.

15. The method of claim 14, wherein said multispectral imaging device is positioned to contact said target object.
